(19) United States
(12) Patent Application Publication
(10) Pub. No.: US 2007/0285660 A1
(43) Pub. Date: Dec. 13, 2007

(54) Method for Measuring Properties of Particles by Means of Interference Fringe Analysis and Corresponding Apparatus

(75) Inventors: Marzio Giglio, Milano (IT); Marco Alberto Carlo Potenza, Milano (IT)

Correspondence Address: MERCHANT & GOULD PC, P.O. BOX 2903, MINNEAPOLIS, MN, 55402-0903, US

(73) Assignee: UNIVERSITA'DEGLI STUDI DI MILANO, Milano (IT)

(21) Appl. No.: 10/589,514

(22) PCT Filed: Feb. 18, 2005
(86) PCT No.: PCT/IB05/00411

§ 371 Date: May 24, 2007

(30) Foreign Application Priority Data
Feb. 20, 2004 (IT) TO2004A000100

(51) Int. Cl. G01N 15/02

(52) U.S. Cl. 356/336

(57) ABSTRACT

A method of measuring properties of particles comprises the steps of: generating a beam of radiation (IB) which is propagated along a principal axis (z), illuminating with the beam (IB) an observation region (MR) with particles (B), a portion of the beam (IB) giving rise to radiation (SW) which is scattered by interaction of the portion of the beam (IB) with the particles (B) and another portion (TB) being transmitted substantially undisturbed through the observation region (MR), and detecting, in a plane (M) disposed on the propagation axis (z), radiation intensity values which are determined by the interference between the scattered radiation (SW) and the transmitted radiation (TB). The method further comprises the steps of: identifying systems of interference fringes associated with the particles (B) in which the interference pattern is affected by a phase delay of the scattered radiation (SW) relative to the transmitted radiation (TB), the delay being determined by the interaction of the radiation beam (IB) with the particles (B), and determining the properties of the particles (B) on the basis of the lower-order interference fringes.

The present invention relates to a method of measuring properties of particles of the type described in the preamble to claim 1.

For the determination of the properties of the particles, the method is based on a wave-scattering process.

Conventional light-scattering techniques for the determination of properties of particles or materials such as information on their size, shape, and structure are based on measurement of the distribution of the intensity of the radiation scattered around the direction of propagation of the beam which is incident on a sample. In general, information on the phase of the waves scattered is lost.

However, the phase of the scattered wave emerging from the centre of scattering contains valuable information. In fact whilst, for particles which are so small as to be negligible relative to the wavelength of the radiation, a spherical wave in phase with the incident radiation is emitted, as the diameter of the particle increases, the wave has a phase difference which increases in dependence on the optical thickness of the particle and hence both on its diameter and on the refractive index. In most cases, and leaving out of consideration values which are abnormal owing to the stepwise difference in refractive index between the scattering element and the surrounding medium, most of the phase change takes place for diameters close to and typically less than the wavelength value. This range of diameters is usually poorly covered by conventional methods since the variation of the scattered intensity with the angle is slight, particularly if observations are limited to very small scattering angles, as is advantageous in order to keep the instrument compact. In fact, in conventional scattering techniques, information on the sizes of particles of this order of magnitude is obtained by sensors which detect the intensity scattered at very large angles relative to the direction of propagation of the incident beam. In this range of sizes, the scattered field depends on the third power of the linear dimension of the particle and the scattered power therefore depends on the sixth power of the linear dimension of the particle, rendering the detection of smaller particles very difficult.

In the past, various types of apparatus have been identified and produced which enable the phase difference between the wave transmitted by the sample and the wave scattered by the particles to be measured.

Finally, it is known that in-line or in-transmission holography techniques have been used to take measurements of particle sizes, particularly by the technique known as “synthetic holography”. Synthetic holography enables the dimensions of the particles to be obtained by a calculation method based on the reconstruction of the image from the system of interference fringes recorded on a suitable sensor. To achieve a high resolution it is necessary to record a large number of interference fringes, in particular it is necessary to record the fringes which are spatially closest together, that is, which originate from the waves that are scattered at large angles (the angles are measured relative to the direction of incidence of the radiation) (H. J. Kreuzer and R. A. Pawlitzek, Europhysics News March/April 2003; F. Dubois, C. Minetti, O. Monnom, C. Yourassowsky, J. -C. Legros, and P. Kischel, Appl. Opt. 41, 4108-4119 (2002)).

The object of the present invention is to provide a method for the analysis and measurement of properties of particles by analysis of the interference between the wave transmitted by the sample and the wave scattered by the particles, which does not require complex optical configurations or data generation and collection techniques for its implementation.

This object is achieved, according to the invention, by a method of measuring properties of particles having the characteristics defined in the claims.

According to the invention, to obtain information on the size of the particles, the method considers an optical arrangement in which the scattered light is caused to interfere with the intense beam transmitted, which thus acts as a phase reference for the scattered wave (a self-reference system). In this condition, since the signal detected in the observation plane is given by the product of the amplitude of the intense field transmitted and the amplitude of the scattered field, the signal detected depends only on the third power of the linear dimension of the particle.

It is important to note that, although the optical arrangement is wholly analogous to that used in synthetic holography techniques, the method of the present invention is based on a different physical principle which enables additional information to be obtained, relative to that which is obtained from a hologram. Whereas synthetic holography techniques are affected by the resolution of the instrumentation which, as stated above, depends on the number of interference fringes recorded, the present invention is based instead on the fact that all of the information on the power of the radiation removed from the wave which is incident on the particle is contained in the wave which, downstream of the scattering, is propagated in the direction of the incident wave, in accordance with what is stated by the so-called “Optical Theorem”. This information is obtained, according to the present invention, by analysis of the position and of the configuration of a few interference fringes produced by the interference between the transmitted field and the scattered wave (generally less than 10-20 fringes), and at the limit of a single fringe, around the optical axis.

A further subject of the invention is apparatus for implementing a method of measuring properties of particles according to the invention.

A non-limiting embodiment of the invention will now be described with reference to the appended drawings in which:

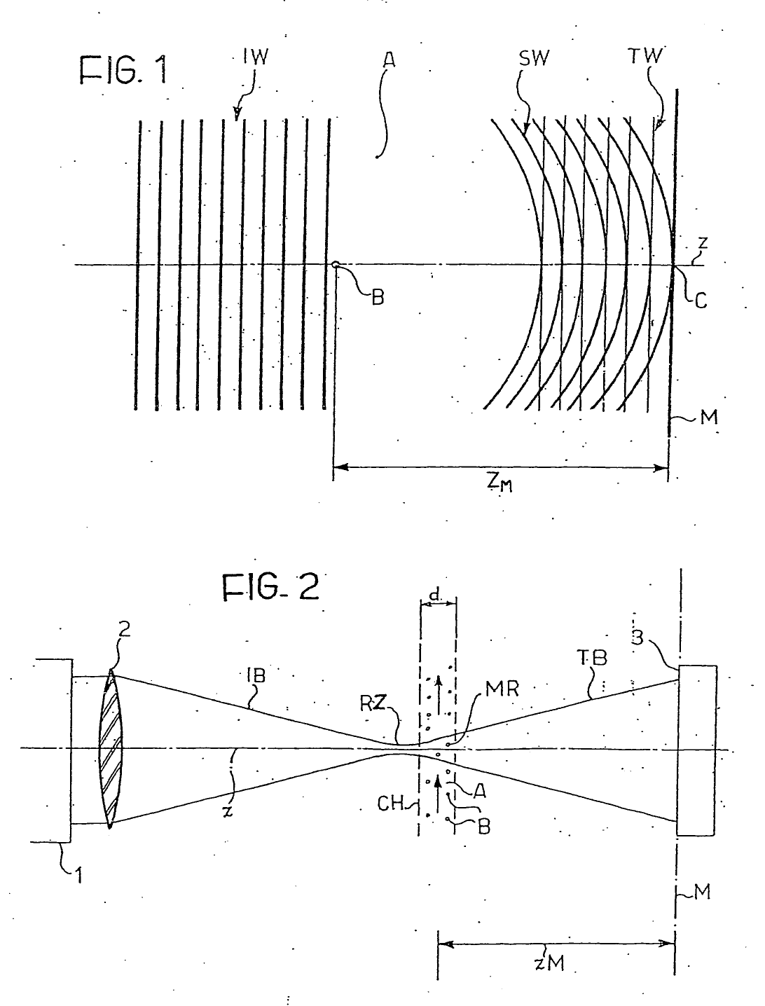

FIG. 1 is a basic diagram which illustrates the phenomenon of the scattering of a wave by a particle,

FIG. 2 is a schematic view of an embodiment of apparatus for implementing a method of measurement according to the invention, and

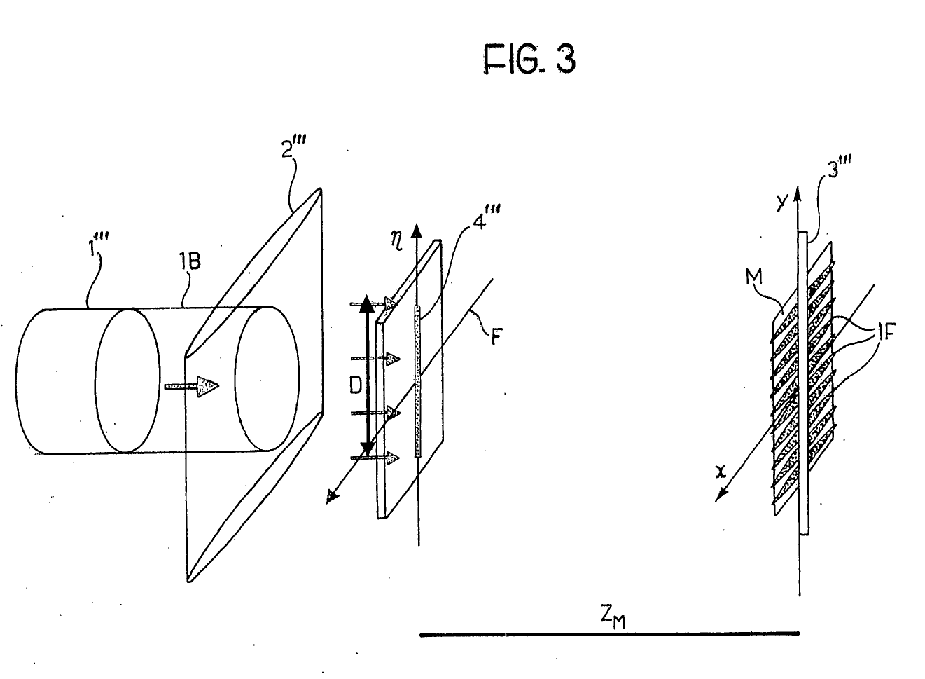

FIG. 3 is a schematic view of a variant of the apparatus of FIG. 2.

The method and the apparatus according to the present invention are based on the following physical principle which is described with reference to FIG. 1.

An electromagnetic wave IW is considered (for simplicity, the wave is illustrated in FIG. 1 as a plane wave); the wave is propagated in a medium A along an axis z and is incident on a particle B. The medium A and the particle B (which may be, for example, a bubble in a transparent, solid or liquid material) have refractive indices of n_{A} and n_{B}, respectively, at the frequency of the wave IW.

The particle B becomes the source of a spherical electromagnetic wave SW. If the particle is spherical and of negligible size relative to the wavelength of the wave IW, the emerging wave SW, which is known as the scattered wave, is in phase with the incident wave IW and therefore also with the transmitted fraction TW of that wave. In a detection plane M of a sensor disposed at a predetermined distance z_{M} from the particle B, the interference between the scattered wave SW and the transmitted wave TW, the amplitude of which is much greater than that of the scattered wave SW, gives rise to a series of circular and concentric fringes the centre C of which lies on the projection of the position of the particle B in the plane M along the axis of propagation z of the radiation IW incident on the particle B. Since the two waves SW and TW are in phase, there is an interference maximum at the centre C of the system of fringes. The radii of these fringes are dictated by the wavelength of the radiation and by the distance z_{M} between the particle B and the sensor plane M. If the particle is non-spherical, the shape of the interference fringes is not circular and enables information to be obtained on the shape of the particle.

The radii of the fringes, raised to the fourth power, are directly proportional to the n^{th} order of the fringes. The proportionality constant is univocally linked with the distance between the particle B and the plane M and with the wavelength.

As the size of the particle B increases, the scattered wave SW has a phase delay which is linked in a known manner with the size and, very weakly, with the difference between the refractive indices n_{B}-n_{A}. As a consequence of this phase difference, at the centre C of the system of fringes, that is, in the direction of the transmitted wave TW, the interference with the scattered wave causes a reduction in intensity.

Naturally, the phase delay also introduces a variation in the radii of the interference fringes.

The linear law described above is, however, maintained and the slope of the straight line is independent of the phase difference but the phase difference determines univocally the intercept at the origin, extrapolated for n=0, which is known as the “fractional order at the centre”. If the phase difference is zero, the fractional order at the centre is zero, that is, there is an intensity maximum. A measurement of the fractional order at the centre therefore provides the phase difference value and consequently the dimensions of the particle B.

The configuration of the interference fringes can advantageously be analyzed in a manner such as also to provide the depth of intensity modulation of the interference pattern. This depth of modulation is determined by the ratio between the amplitude of the scattered field and the amplitude of the incident field. It also consequently contains information on the amount of radiation removed from the beam and therefore on the size of the particle.

If the incident radiation beam IB is a converging beam, a study of the fringes produced by the interference between the scattered wave SW and the transmitted beam TB again contains all of the information of the previous case. Some differences will be pointed out.

It is necessary to distinguish between the situation in which the particle or particles B occupy positions close to the focal plane (the plane of smallest diameter of the beam) or, on the contrary, are outside that region.

For particles remote from the focal plane, the foregoing discussion remains substantially unchanged except for the fact that, in general, the fringes in a plane at a distance z_{f} from the focus have larger diameters than for a plane wave. This is due to the fact that, in the plane of observation, the radii of curvature of the scattered wave SW and of the transmitted beam TB have smaller differences than in the case of a plane incident wave. Moreover, because the converging beam IB (which, for simplicity, is considered to be a beam with a Gaussian intensity profile) has a finite diameter in the plane at distance z_{f}, the number of fringes may be reduced. Apart from these unimportant limitations, it remains true that quantitative information on the optical thickness (and hence on the diameter and on the refractive index) of the particles and on their position can be obtained from the measurement of the fractional order at the centre and from the depth of the intensity modulations of the interference pattern.

A separate case is constituted by positions of the particles in the region around the focus which region, in the case of a Gaussian beam, is defined by the so-called Rayleigh range. Naturally for particles in these positions, the phase difference between the scattered field and the spherical scattered wave becomes very small and, at the limit, for a particle positioned precisely in the plane of smallest diameter of the beam and on the optical axis z, the degenerate case exists in which the scattered wave and the transmitted beam have precisely coincident surfaces in constant phase. In this case there is absolutely no intensity variation due to interference throughout the field (flat colour). As will be shown, this apparently adverse situation is the most suitable for certain applications since, if the particle B is displaced perpendicularly to the optical axis z along the diameter of the beam in the focal plane, the intensity distribution changes because of the interference between the transmitted wave TW and the scattered wave SW which, in this situation, form a slight angle and produce variations of intensity in large portions of the transmitted beam TB. This configuration permits the use of so-called quadrant sensors which, by operating in a differential manner, permit great sensitivity.

Still with reference to particles in the focal region, it is also added that, in that region, the effect of the so-called “phase anomaly” is to be considered; this describes the anomalous phase shift of the incident field in that region. The entire phase shift along the optical axis z amounts to π. The difference between the phases of the spherical wave SW scattered by a particle disposed at the focus and the transmitted beam TB therefore amounts to π/2, that is, the phase of the scattered wave SW is precisely in quadrature with the transmitted beam. As a result, the interference does not change the power of the transmitted field and the total cross-section of scattering of the radiation by the particle is zero, in accordance with the theory in the case of infinitely small particles. If the particle is displaced transversely relative to the optical axis z, a weakening and an increase in intensity in the transmitted beam TB are created in two opposed lobes disposed along the direction of the displacement of the particle.

As the dimension of the particle B increases, the phase difference between the scattered wave SW and the incident beam IB increases, reaching the maximum value of π and the two waves are then in phase opposition. In this case, if the particle B is displaced transversely relative to the beam IB, the interference between the scattered wave SW and the transmitted wave TW weakens the entire transmitted beam TB, no longer showing the weakening and the increase in intensity on opposite sides as in the previous case. In this case, the interference creates a slight, almost entirely symmetrical shadow over the entire beam. There is nevertheless a weak asymmetry in the distribution of the power removed, because of the displacement of the particle B relative to the optical axis z.

A schematic example of a possible embodiment of the apparatus with which measurements on particles can be taken in accordance with the present invention is shown in FIG. 2. The apparatus comprises an electromagnetic radiation source 1 suitable for producing a beam of radiation IB which has a range of frequencies centred about a predetermined frequency ω, corresponding to a wavelength of λ in a vacuum. Downstream of the source 1 along the propagation axis z of the beam, there are optionally a spatial filter (not shown) and beam shaping optics 2.

The source 1 preferably emits visible or infra-red light and is constituted, for example, by a light-emitting diode or by a semiconductor laser or a laser of another type, according to measurement requirements. In general, the use of sources of radiation with a band that is not too narrow appreciably reduces effects due to spurious or multiple interference. For some applications, the source may advantageously emit radiation distributed around several wavelength values (an arrangement known as a “multi-coloured source”).

The particles to be analyzed may be composed of any solid or fluid substance, material or element (aerosol, drops, bubbles). The particles may be arranged in a stationary manner or may move within the medium A. The medium A may be solid or fluid but in any case must be transparent to the frequency/ies of the incident radiation used. Moreover, the density of the particles in the medium A (the number of particles per unit of volume) must allow at least part of the incident wave IW to be transmitted.

In other words, the density of the particles within the measurement volume must be quite low so that all of the fringe systems can be detected with good definition. In these conditions the intensity of the transmitted beam is certain to be practically unchanged.

For particles B which are dispersed in a fluid medium A, a suitable conventional method of confinement ensures that only one particle at a time is present in an observation region MR struck by the beam IB. As is shown in FIG. 2, the confinement is achieved, for example, by means of a duct CH which has walls that are transparent to the radiation of the beam IB and which conveys the medium A in which the particles B are dispersed through the observation region MR. In FIG. 2, the incident beam IB is shown as a focused laser beam. The observation region MR through which the particles B are conveyed has a width d along the axis z of the beam IB which is thin enough to allow a single particle B at a time (or at most a few particles) to pass through the region MR. For reasons concerning the amplitude of the signals, it is advantageous to focus the beam in a manner such that the particles pass through the beam in the vicinity of the focus so that the intensity of the field incident on the particles is suitably high. As is known, in the vicinity of the focal plane, a wave in fact exhibits the “phase anomaly” phenomenon and, to simplify data analysis, it is preferable for the particles to be used in regions outside the so-called Rayleigh range so that phase anomaly effects are minimized.

As described above, a particle disposed at the focus (in the plane of smallest diameter of the beam) and on the optical axis z of the system emits a spherical wave perfectly in phase with the incident beam and interference fringes are therefore not observed. This type of geometry is used in apparatus developed in the past for the measurement of the phase difference between the scattered wave and the incident wave (see U.S. Pat. No. 5,037,202 and J. Batchelder and M. Taubenblatt, Appl. Opt. 30, 4972-4979 (1991)). In these conditions, however, the particles necessarily have to pass through the exploring beam in the plane of smallest diameter and in a diametral direction (that is, passing through the centre). For this purpose, so-called signal “validation schemes” are necessary; these indicate which signals are produced by the passage of the particle in the diametral direction and therefore provide the correct value for the phase difference. Although, on the one hand, this arrangement permits the use of simple sensors (with a single sensitive element and without any determination of the intensity distribution in the observation plane), on the other hand, it requires complex optical systems such as, for example, a Nomarski system and the use of Wollastone polarizing prisms, with limited sampling and data collection frequency.

If the particles are caused to pass through the region of smallest diameter of the beam (not shown), a variant of the present invention advantageously enables the information relating to the dimensions of single particles to be obtained and the position of transit through the beam to be determined by means of apparatus which is simpler than the types of apparatus developed in the past and mentioned above.

This result is achieved on the basis of an analysis of a plurality of intensity values measured by suitable sensitive elements as stated above. When the particle passes in the vicinity of the plane of smallest diameter of the beam, perpendicularly to the propagation direction z, the distribution of intensity has variations due to the interference between the transmitted beam TB and the scattered beam SW. The size of the regions in which the intensity variations occur is very large in this case and therefore permits the use of sensors having sensitive elements of large area which therefore receive a large fraction of the power scattered by the particle. Moreover, if the particle does not pass through the beam diametrally, the consequent asymmetry of the interference pattern provides a method of determining the transit position.

Another embodiment (not shown) of the present invention is constituted by apparatus in which the light beam IB is substantially collimated and is directed through the sample constituted by the particles B. In this case, it may be preferable to use means suitable for magnifying the image of the interference fringes obtained in a suitably selected observation plane M. These means may be represented by optical elements.

A device 3 for collecting and recording the radiation coming from the observation region MR is aligned on the propagation direction z of the radiation IB, that is, on the optical axis of the system. The radiation detected comprises scattered radiation produced by the scattering interaction of the incident radiation IB with the particles B in accordance with the principle described above and a portion TB formed by a fraction of the incident beam IB which is transmitted undisturbed through the observation region MR. The device 3 is formed by a plurality of sensor elements which can detect a plurality of electromagnetic radiation intensity values, and which are disposed in the plane M. Preferably, the sensor elements of the device 3 are arranged in a manner such as to form a rectangular matrix of sensor elements each of which can detect an electromagnetic radiation intensity value at a distinct point. Even more preferably, the device 3 comprises a CCD sensor or a CMOS or NMOS sensor. The device 3 can thus detect the interference fringes produced, in accordance with the principle described above, by the interference of the radiation scattered by the particles B with the transmitted beam TB at the distance z_{M} of the device 3 from the particle B. Means (not shown) for obtaining, in the device 3, a suitable distribution of the radiation connected with the interference fringes are optionally interposed between the particle to be analyzed and the sensor device 3. These means may be constituted, for example by an optical system.

The sensitive elements of the sensor device 3 detect a plurality of radiation intensity values, one for each of the sensitive elements, and supply corresponding signals to a processing unit (not shown).

The processing unit is programmed to determine the dimensions and optionally the shape of the particles by analysis of the lower-order fringes defined by the measured radiation intensity values. An example of a method of processing the data collected in a measurement performed by apparatus as described above or in another foreseeable embodiment consists of the following steps:

a) recording, at a fixed distance z_{M} from the region MR, an intensity distribution I(x,y) which, in the presence of a particle in the beam, provides the fringes due to the interference between the scattered wave and the transmitted wave (x and y are the coordinates of the points in the detection plane M of the sensor 3);

b) recording a suitable sample of intensity distributions Iᵢ(x, y) to obtain an intensity distribution I₀(x, y) which is a good representation of the intensity distribution in the absence of the particle;

c) processing the data thus obtained to obtain a distribution J(x,y)=(I(x,y)−I₀(x,y))/I₀(x,y) which provides the interference fringes with good contrast, normalized for the intensity incident on the particle;

d) processing the data relating to the intensity distribution J(x,y) for the characterization of the interference fringe configuration in terms of the radius values and shape;

e) processing the data relating to the configuration of the interference fringes to determine the fractional order at the centre and, from the measurement of the depth of modulation, the scattered amplitude and hence the dimension and the shape of the particle.

In the example described above, the functions I(x,y) and J(x,y) are representative of the interference fringes, whereas I₀(x,y) represents the intensity of the beam transmitted in the absence of particles.

A variant of the measurement method according to the present invention may advantageously be implemented, for example, when the particles pass through the focal region of the beam, by means of a sensor device 3 the sensitive elements of which detect a plurality of radiation intensity values as a function of time during the transit of the particle through the beam, one value for each of the sensitive elements, and supply corresponding signals to a processing unit (not shown). These sensor elements of the device 3 may be represented, for example, by photodiodes. A preferred embodiment is represented by so-called quadrant photodiodes. As discussed above, since the particles pass through the focal region of the beam, the intensity modulations are extended over appreciable fractions of the beam so the sensitive elements can have available a very extensive area such that they detect a large fraction of the power scattered by the particles. This aspect is particularly advantageous for the purposes of the present invention since the measurement uncertainties relating to the so-called “shot noise” are thus reduced and therefore permit the measurement of particles of sizes much smaller than the wavelength. The sensor elements of the device 3 are arranged in a manner such as to measure the variation in intensity over time in suitable fractions of the beam transmitted upon the passage of a particle B through the incident beam IB. Even more preferably, the sensor elements may be arranged in a manner such as to select the particles which are passing through the centre of the incident beam IB by analysis of the asymmetry of the signal (that is, so as to pick up solely the fringes of the particles which are passing through the centre, or even better, to determine substantially the position of transit of the particle through the beam). The variation of the intensities measured by the individual sensor elements of the device 3 over time provides: 1) information on the depth of modulation of the interference pattern and 2) the phase difference between the scattered wave and the transmitted wave. This information enables the optical thickness of the particle and hence the size and refractive index to be determined on the basis of the present invention.

The sensitive elements of the sensor device 3 detect a plurality of radiation intensity values, one for each of the sensitive elements, and provide corresponding signals to a processing unit (not shown).

The processing unit is programmed to determine the dimensions of the particles by analysis of the time dependence of the amplitude of the signals or of suitable combinations thereof. A non-limiting example of a method of processing the data collected in a measurement performed by apparatus as described above or with another foreseeable embodiment consists of the following steps:

k) recording a plurality of radiation intensity values at a suitable distance z_{M} from the sample. For example, four values which are provided by a quadrant photodiode and which will be indicated 1, 2, 3, 4 (following the convention on the anticlockwise order of the quadrants in the plane starting from the top right-hand quadrant, and assuming that the particle passes through the beam from the top towards the bottom);

l) recording a set of such intensity values as a function of time so as to determine the variation of those values as a function of time in each of the sensitive elements;

m) analysis of the signals collected in order to determine the position of transit through the beam in the plane perpendicular to the optical axis (for example, by the difference of the signals from the sensitive elements that are disposed on opposite sides of the direction of transit of the particle, that is 2+3−1+4). Consequent selection of the particles the signals of which are to be analyzed, or optionally of the most suitable analysis method;

n) analysis of the signals collected to determine the position of transit through the beam in the longitudinal direction (for example, on the basis of analysis of the time dependence of the difference values and of the sum values of the impulses coming from suitable sensitive elements, that is, 1+2, 3+4). Consequent selection of the particles the signals of which are to be analyzed;

o) analysis of the signals collected to determine the depth of modulation due to the interference between scattered wave and transmitted wave. For example, by means of the time dependence of the difference of the values recorded by the sensitive elements during the transit of the particle (1+2−3+4);

p) analysis of the signals collected to determine the time dependence of the sum of the values recorded by the sensitive elements in the absence of the particle and during the transit. For example, 1+2+3+4. Comparison with the corresponding value obtained in the absence of the particle in the beam and determination of the power removed;

q) determination of the particle dimensions. Determination of other properties that can be obtained by the method in accordance with foreseeable procedures (for example, refractive index).

A further variant of the measurement method according to the present invention may advantageously be used when more than one particle are present simultaneously in the observation region MR struck by the beam IB so as to produce more than one system of interference fringes in the plane M in which the radiation intensity is recorded. In this case, the apparatus consists of embodiments in which the sample to be analyzed lies outside the Rayleigh region of the beam, or those in which the incident beam is substantially collimated. The method is identical to the preceding one in steps a) to c) and subsequently consists of the following steps:

d′) processing the data obtained in order to perform an identification, by a suitable image analysis procedure, of the centres Cᵢ of the fringe systems (i is a whole number which identifies the i^{th} fringe system).

The data relating to the configurations of the interference fringes can then be processed, for example, in accordance with steps d) and e) of the method described above.

Another variant of the measurement method according to the present invention relates to the more complex situation in which a large number of particles is simultaneously present in the observation region MR, in which the beam has a large cross-section in the sense which will be explained further below. In this situation, in a plane M disposed at a fixed distance z_{M} from the observation region MR, the intensity distribution appears very complex since it is the sum of many interference-fringe systems produced by the individual particles. The signal has all of the characteristics of noise and is comparable to a so-called speckle field. A large beam therefore means a beam substantially larger than the typical dimension of the first fringes of the interference patterns. In this case the optical configuration may be modified suitably, for example, by illuminating the sample with a collimated radiation beam and recording the superimposition of the interference fringes downstream of the sample, at a suitably selected fixed distance z_{M}. In the case of a collimated beam, this distance will therefore have to be such that the relationship z_{M}>a²/λ is satisfied, where λ is a characteristic value for the wavelength of the radiation used and a is a dimension which is characteristic of the particles contained in the observation region (MR), so that each sensor element receives the radiation scattered by a large number of particles so as to permit processing of the data by statistical analysis of the measurements.

In this case it is not possible to extract an individual fringe system from the extremely complex superimposition of fringe systems positioned randomly in the plane M. However, it is possible to use a statistical method based on the calculation of the power spectrum of the intensity distributions recorded. This gives a function which is biunivocally linked with the intensity distribution of the interference fringes of a single particle and the information on the phase differences can be recovered. For example, for very small particles, the power spectrum becomes the transfer function of the optical technique known as the Shadowgraph technique, which exhibits a low minimum at zero for the scattering wave vector value q=2π/λ sin(θ/2), where θ represents the angle formed between the direction of the scattered radiation and the direction of the incident radiation. As soon as the diameters of the particles become larger, the intensity minimum at q=0 is gradually transformed into an ever larger peak, enabling the measurement of the fractional order at the centre of the system of fringes produced by each individual particle to be deduced.

In this case, an example of a method of processing of the data collected consists of the data analysis method commonly used for quantitative Shadowgraph measurements, an example of which is represented by the following steps:

a″) recording a number N of intensity distributions Iᵢ(x,y) in the presence of particles in the beam,

b″) processing the data relating to the N intensity distributions Iᵢ(x,y) to obtain an intensity distribution I₀(x,y) which is a good representation of the static intensity distribution due to the transmitted beam in the absence of the signal due to the particles;

c″) processing the data obtained to obtain a distribution Jᵢ(x,y)=(Iᵢ(x,y)−I₀(x,y))/I₀(x,y) which provides the superimposition of the interference fringes with good contrast;

d″) processing the data relating to the distributions Jᵢ(x, y) to obtain two-dimensional power spectra Jᵢ(qₓ,q_{y});

e″) processing the data obtained in step d″) by averaging the two-dimensional power spectra to obtain a two-dimensional power spectrum J(qₓ,q_{y});

f″) processing the data relating to the two-dimensional power spectrum J(qₓ,q_{y}) to obtain, since the distance z_{M} and the geometry of the apparatus are known, the fractional order at the centre of the interference fringes the superimposition of which determines the intensity distributions recorded, Iᵢ(x,y), and

g″) processing the data relating to the fractional order at the centre to obtain the particle size by known methods.

In this case, the intensity distributions Iᵢ(x,y) represent complex superimpositions of numerous interference fringes which are comparable to speckle fields.

The foregoing indicates that the present invention can usefully be utilized to widen the field of use of the recently proposed technique called the Near Field Scattering Technique, which is described in International patent application WO 02/103332.

Another variant of the apparatus for implementing the method according to the invention is shown schematically in FIG. 3. It comprises an electromagnetic radiation source 1″′ as described for the previous embodiments, downstream of which are beam shaping optics 2″′ comprising a cylindrical lens which forms in its focal plane η a thin blade of radiation 4″′ of width D. The fringes IF produced in the detection plane M by the interference between the radiation transmitted and that which is scattered are thus greatly deformed. Single-dimensional analysis of the interference fringes thus obtained can be performed in the plane η in which the thin beam of radiation 4″′ lies to obtain the information relating to the fractional order at the centre of each system of fringes produced by particles struck by the thin beam of radiation 4″′. Moreover, since the information is thus one-dimensional, a one-dimensionally arranged system of sensors 3″′ can be used, rather than a rectangular matrix system. This embodiment is particularly advantageous for the measurement of particles that are immersed in a flowing fluid which can be caused to flow perpendicularly relative to the thin beam of radiation 4″′, in the direction of the arrow F. The data collected can thus be analyzed as described in the method examples given above.

The methods described above, as well as other possible embodiments of the present invention, may require a large number of acquisitions, for example, to be able to reduce the noise which inevitably afflicts the measurement and thus to obtain an adequate determination of the properties of the particles under examination.

The invention is not intended to be limited to the embodiments described and illustrated herein which should be considered as examples of the implementation of the method and of the apparatus for the measurement of properties of particles; rather, the invention may undergo modifications relating to the shape, construction and arrangement of parts, constructional details, and data-acquisition and data-analysis methods.

Moreover, the invention is not necessarily limited to the measurement of properties of solid particles in a fluid medium but may be used for the measurement of the properties of materials which can be deduced by measurement of the phase difference between the scattered waves and the transmitted wave as described above, in accordance with possible variants which will seem appropriate to persons skilled in the art and which should be understood as being included within the scope of the invention as defined in the appended claims.

1. A method of measuring properties of particles, comprising the steps of:
generating a beam of radiation which is propagated along a principal direction,
illuminating with the beam an observation region which is occupied or transited by a plurality of particles, a portion of the beam giving rise to radiation which is scattered by scattering interaction of that portion of the beam with the particles, and another portion being transmitted substantially undisturbed along the principal axis through the observation region, and
detecting, in a plane disposed on the propagation direction, a plurality of radiation intensity values which are determined by the interference between the scattered radiation and the transmitted radiation,
identifying systems of interference fringes associated respectively with the individual particles in which the interference pattern is affected by a phase delay of the scattered radiation relative to the transmitted radiation, the delay being determined by the interaction of the radiation beam with the particles, and
determining the properties of the particles on the basis of the fringes that are affected by the phase delay.

2. A method according to claim 1 in which the identification of the interference fringe systems comprises a determination of the fractional order at the centre relative to the individual fringe systems.

3. A method according to claim 1 in which the identification of the interference fringe systems comprises a determination of the depth of intensity modulation relative to the individual fringe systems.

4. A method according to claim 1 in which the radiation beam has a plane wave front.

5. A method according to claim 4 in which the detection plane is disposed at a predetermined distance z_{M} from the observation region such that the relationship z_{M}>a²/λ is valid, where λ is a characteristic value for the wavelength of the radiation used and a is dimension which is characteristic of the particles contained in the observation region.

6. A method according to claim 1 in which the radiation beam is focused in the vicinity of the observation region.

7. A method according to claim 6 in which the position of the observation region is selected so as to be outside the Rayleigh zone close to the position of smallest diameter of the beam.

8. A method according to claim 1 in which the radiation is focused by means of a cylindrical lens so as to form a thin blade of light which illuminates the observation region substantially one-dimensionally.

9. A method according to claim 1 in which the illumination and the detection are performed from opposite sides of the observation region.

10. A method according to claim 1, arranged so as to determine the fractional order at the centre of the system of interference fringes produced by a single particle at a time.

11. A method according to claim 1 in which the detection of the plurality of radiation intensity values determined by the interference between the scattered radiation and the transmitted radiation comprises a measurement of the variation of the intensity values over time upon the passage of a particle through the incident beam,
the determination of the properties of the particle being based on the variation over time of the fringes that are affected by the phase delay.

12. A method according to claim 11 in which the determination of the properties of the particles presupposes the determination of the position of transit of the particle through the incident beam by analysis of the asymmetry of the variation over time of the intensity values measured.

13. A method according to claim 11 in which the measurement of the variation of the intensity values over time takes place by selection of the zone of transit of the particles.

14. A method according to claim 1 in which the determination of the interference fringe systems associated respectively with the particles comprises a determination of the centres of a plurality of interference fringe systems produced by a corresponding plurality of particles.

15. A method according to claim 14 in which the determination of the interference fringe systems associated respectively with the particles comprises a determination of a power spectrum of the electric field corresponding to the plurality of radiation intensity values.

16. A method according to claim 1 in which the determination of the properties of the particles on the basis of the lower-order fringes of the system of fringes is programmed in a manner such as to determine the distribution of the dimensions of the particles.

17. Apparatus arranged for implementing a measurement method according to claim 1, comprising:
a source of the radiation beam, suitable for illuminating the observation region,
sensor means suitable for detecting the radiation at a plurality of points simultaneously and for making available a signal indicative of the detection, the sensors being disposed on the propagation axis in a manner such as to detect a plurality of radiation intensity values which are determined by the interference between the scattered radiation and the transmitted radiation, in which the interference is affected by a phase delay of the scattered radiation relative to the transmitted radiation, the delay being determined by the interaction of the radiation beam with the particles, and
processing means which are programmed to determine, on the basis of the signal, interference fringe systems associated respectively with the individual particles, and to determine the properties of the particles on the basis of the fringes which are affected by the phase delay.

18. Apparatus according to claim 17, further comprising lens means interposed between the observation region and the sensor means so as to permit indirect detection by detection of the plurality of intensity values in an optically conjugate plane.

19. Apparatus according to claim 17, further comprising a system for shaping the wave front, based on cylindrical optics such as to form a thin blade of radiation for the illumination of the observation region.

20. Apparatus according to claim 17, further comprising a system for shaping the wave front, suitable for focusing the radiation in the vicinity of the observation region.

21. Apparatus according to claim 17, further comprising a system for shaping the wave front, suitable for collimating the radiation that is incident on the observation region.

22. Apparatus according to claim 17 in which the sensor means comprise a CCD, NMOS or CMOS sensor.

23. Apparatus according to claim 17 in which the sensor means comprise a plurality of photodiodes arranged in manner such as to detect, as a function of time, the intensity distribution produced by the interference between transmitted radiation and scattered radiation.

24. Apparatus according to claim 23 in which the photodiodes are arranged in a manner such as to pick up selectively radiation coming from predetermined zones of transit of the particles.

25. Apparatus according to any claim 17 in which the source is a multi-coloured source.
